(19) United States
(12) Patent Application Publication
(10) Pub. No.: US 2024/0013677 A1
(43) Pub. Date: Jan. 11, 2024

(54) VISUAL TRAVEL GUIDE SYSTEMS INCLUDING DRIVING INSTRUCTION

(71) Applicants: John Cortese, Brooklyn, NY (US); Miguel Florez, Highlands Ranch, CO (US)

(72) Inventors: John Cortese, Brooklyn, NY (US); Miguel Florez, Highlands Ranch, CO (US)

(21) Appl. No.: 17/860,626

(22) Filed: Jul. 8, 2022

(51) Int. Cl. G09B 19/16; G06Q 20/14; G06F 16/43; G09B 5/06

(52) U.S. Cl. CPC G09B 19/167; G06Q 20/14; G06F 16/43; G09B 5/065; G06F 3/04817

(57) ABSTRACT

A system for providing a visual tour guide including driving instruction may include a media database including instructional videos and traditional tour guide and map files. The instructional videos may also include videos generated by a driver in a foreign country with a 360 degree camera. The user may change the field of view to emulate the driver turning their head. Graphics representative of traffic signs and testing material may be overlaid over the video. The system may provide a live stream driving experience. The user provides a desired destination, which is sent to a driver near the destination. The driver may have a 360 degree camera mounted to their vehicle, and the system can transmit the live stream video to the driver. The system may also include a driving environment incorporating VR and/or AR aspects, which may be based on real world traffic or completely simulated.

### TECHNICAL FIELD

The technical field of the disclosed embodiments relate to an online visual travel guide. More particularly, the disclosed embodiments relate to a visual travel guide including driving instruction for a country or countries selected by the user.

### BACKGROUND

A traveler planning a trip to a foreign destination may typically plan and prepare an itinerary for the trip. However, travel itinerary planning can be a difficult and time-consuming task, especially for a traveler visiting a destination for the first time.

In addition to research to identify points-of-interest (POIs) to visit, getting around in a foreign country poses its own problems that won't necessarily be mitigated by a map or mobile map applications. Whether the traveler and their companion(s) are traveling by foot, private or rented vehicle, or public transportation, differences in traffic rules, signage, local customs, and potential language barriers can cause confusion, frustration, and potential safety concerns. In fact, according to the Centers for Disease Control, Road related incidents are the leading cause of non-natural death for healthy Americans abroad.

### SUMMARY

A system for providing a visual tour guide including driving instruction according to an embodiment includes a system platform in communication with user/subscribers and a media database including instructional videos and traditional tour guide and map files.

The instructional videos may include animated tutorials with driving instructor commentary that describe the various aspects of driving in a foreign country. The instructional videos may also include 360 degree videos generated by a driver/videographer in a foreign country with a 360 degree camera. A driving instructor may provide commentary related to the various traffic situations presented in the video. The user may change the field of view (FOV) to emulate the driver turning their head, e.g., to look left, right, or forward. Graphics may be overlaid over the video. The graphics may include representations of traffic signs encountered in the video. The graphics may also include testing materials to quiz the user about various traffic situations. The graphics may also include “click-on” icons associated with objects shown in the video, e.g, signs, and provide additional information to the user when selected.

The media database may include 360 video files for alternative routes. The user may select the alternative routes by selecting an arrow corresponding to a desired direction at an intersection.

The system may provide a live stream driving experience connecting a remote user to a driver in a location selected by the user. The user may select a destination and the system controller may transmit global positioning system (GPS) data representative of the destination to the driver.

The driver may have a 360 degree camera mounted to their vehicle. The system controller may transmit the live stream video to the user and allow the user to change the FOV. The system controller may facilitate communication between the user and driver, e.g., via microphones, speakers, text, etc. The system may also provide a map to the user representing the driver's location.

The system may also provide a “metaverse” driving experience to the user using virtual reality (VR) and/or augmented reality (AR) features. The system may generate a driving environment including digital representations of real-world objects, such as vehicles, roads, signs, buildings, etc. The driving environment may be based on real-time traffic in a location selected by the user or be completely simulated. The driving environment may be used for driver education in the user's home country or a foreign country. The driving environment may also incorporate a multi-player game-type aspect in which other remote users have vehicle avatars in the driving environment.

### BRIEF DESCRIPTION OF THE DRAWINGS

FIG. 1 shows a system for a visual travel guide including instruction for personal transportation in a user-selected country or countries according to an embodiment.

FIG. 2 shows an introductory frame of an animated tutorial video for driving in the United Kingdom (UK) according to an embodiment.

FIG. 3 shows a frame of the animated tutorial video of FIG. 2 describing left and right turns from the left hand lane.

FIG. 4 shows a frame of the animated tutorial video of FIG. 2 describing an automobile layout for an automobile designed for “left side” driving.

FIG. 5 shows a forward facing perspective of an intersection using a 360 video according to an embodiment.

FIG. 6 shows another perspective of the intersection directed toward the right using the 360 video according to an embodiment.

FIG. 7 shows text for a quiz overlaid on the 360 video according to an embodiment.

FIG. 8 shows “click-on” icons for certain objects in the 360 video frame that may be selected for additional information according to an embodiment.

FIG. 9 shows arrows overlaid on the 360 video the user may select from in order to choose a route according to an embodiment.

FIG. 10 shows a system for facilitating a live stream driving experience according to an embodiment.

FIG. 11 shows an exemplary display for a live stream drive with a local driver according to an embodiment.

### DETAILED DESCRIPTION

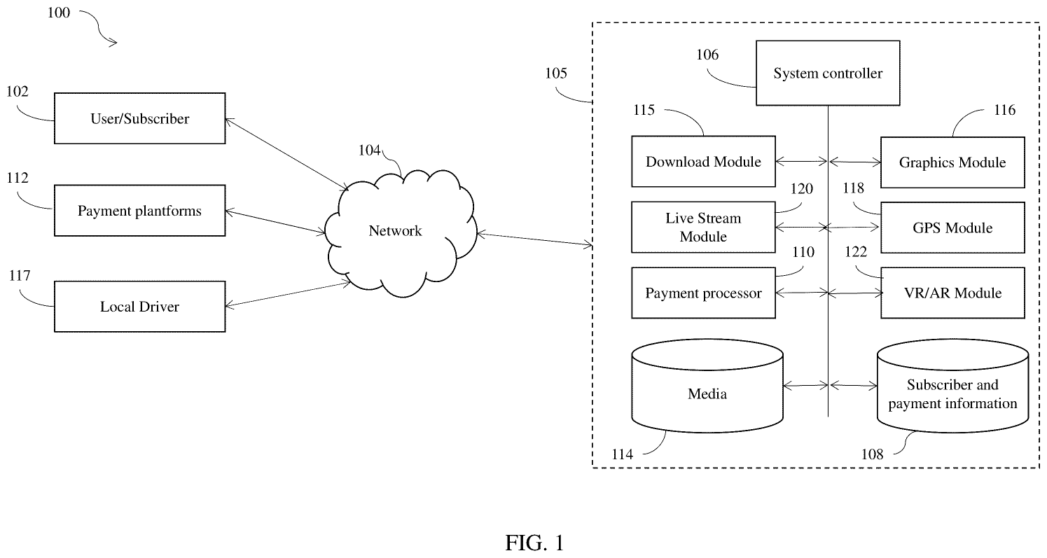

FIG. 1 shows a system 100 for a visual travel guide including instruction for personal transportation in a country or countries selected by a user 102. The user may access the system via a wireless network 104, such as the Internet. The system may include a system platform 105 with various modules and databases to support the various services offered by the system. These modules and databases may be controlled by a system controller 106.

The system 100 may provide a website offering different packages including instructional material for different modes of personal transportation specific to different countries or regions. The modes of transport may include, for example, automobile, motorcycle or scooter, public transportation, bicycling, walking, etc. The user may select one or more packages depending on their travel plans and subscribe to services provided by the system. To subscribe, the website may provide prompting information on linked web pages that request the user to provide personal and billing information, which is stored in a subscription information database 108 on the system platform. Once payment for the subscription service has been negotiated by a payment processor 110 at the system platform with an outside payment platform 112, such as a credit/debit card payment system, PayPal, Google Pay, etc., the user may be granted access to system services.

Travel guide packages may include, for example, animated tutorial videos, 360 degree videos (or “360 videos”) showing a driver's perspective from a vehicle, text and/or multimedia tourist guides, maps, and other files. Travel guide files for different packages may be stored on a media database 114. The system controller may provide the user access to the media files for their travel guide package upon request. Alternatively, a download module 115 may provide an encrypted, downloadable version of the files the user can access offline during their subscription period.

The travel guide package may include animated tutorial videos on different topics. The videos may include voice-over commentary by an instructor to compliment the topics covered in a video. These topics may include a number of essential topics, for example:
Types of road markings and signs;
Road crossings and intersections;
Driving with cyclists on the road;
Local driving etiquette;
Speeding and tolls;
Common rules, laws, fines and driving with children;
Parking and fuel stations;
Paperwork and insurance, etc.

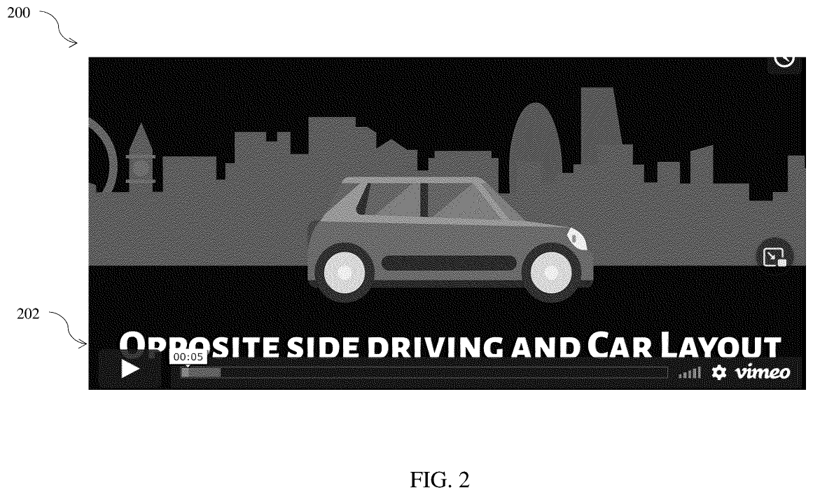

FIGS. 2-4 show frames from an animated tutorial video for driving in the United Kingdom (UK), which includes the countries England, Wales, Scotland, and Northern Ireland. This particular video is directed to educating the user about driving on the opposite side of the road in comparison to North American driving conventions (left side vs. right side). The video emphasizes the change in perspective the user will need to internalize to safely drive in the UK. FIG. 2 shows in introductory frame 200 of the video with the title 202 “Opposite Side Driving and Car Layout.”

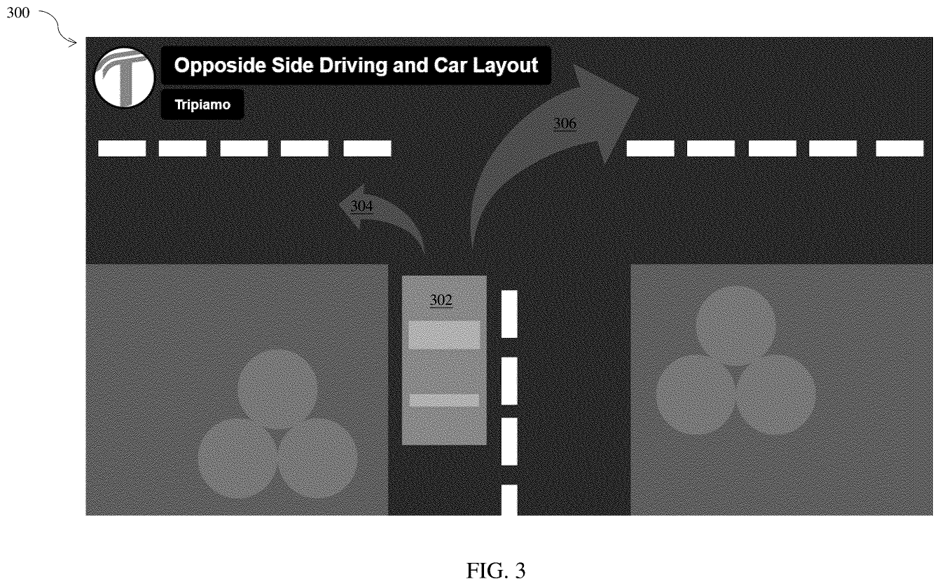

FIG. 3 shows a frame 300 of the video describing how turning left and right differs from “right side” driving, where a vehicle 302 in the left-hand lane (“correct lane”) requires a smaller turning radius for a left hand turn, indicated by arrow 304, than a right hand turn, indicated by arrow 306. The accompanying audio commentary discusses various aspects relating to this difference in perspective, for example, the relative importance of looking to the left and right for a specific turn in comparison with driving in North America.

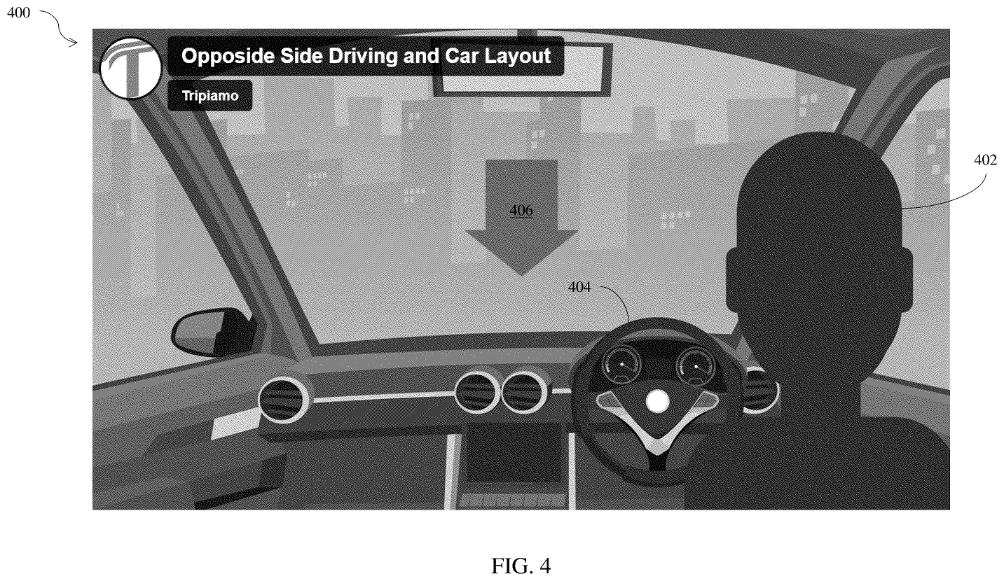

FIG. 4 shows a frame 400 of the video showing the interior layout of an automobile designed for driving in the UK. A graphical representation of the driver 402 and steering wheel 404 are shown to be on the right side of the vehicle, and an arrow 406 indicates the location of the gear shift in the center console. The accompanying audio commentary reminds the user to remember the correct side of the car to enter as a driver or as a passenger.

In an embodiment, the user may access 360 videos showing different traffic situations in a particular country from an actual local driver's perspective. The 360 videos may be taken using a 360 degree camera, or “360 camera,” mounted on the driver's vehicle.

A 360 camera may include two lenses on opposing sides of the camera body. 360 cameras may use fish eye lenses to capture a panoramic view including over 180 degrees of image per lens. Combined, each lens will capture over 360 degrees of total image. After the footage is captured, software may stitch together the images to make the image seamless. The 360 videos taken with the 360 camera may be stored in the media database 114.

The 360 video may be re-framed by taking the 360 video and transforming it into a “normal” video with key frames indicating to the display software which perspective to display at any one time, which is typically 60 to 70 degrees for a video. This may give the appearance that the camera has been moved to a new angle, wherein in actuality, it is merely the video file that has been manipulated.

The system may include a graphics module 116 to overlay graphics on portions of the 360 video images. The graphics module may retrieve various graphics from a memory or database. These graphics may include, for example, graphics representing traffic signals, road signs, icons, text, etc. The video may also include an audio track, for example, a running commentary by a driving instructor.

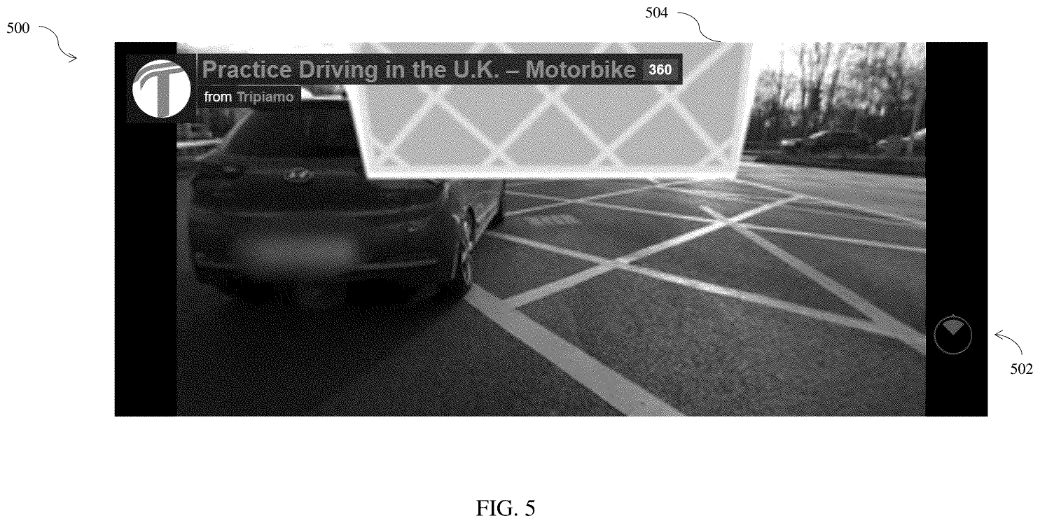

FIG. 5 shows a perspective of an intersection facing forward using a 360 video mounted to a motorcycle. The video may be provided as a learning tool for driving in a foreign country. As described above, the system may provide packages for different countries. In this case, the 360 video shows a driving example in the UK.

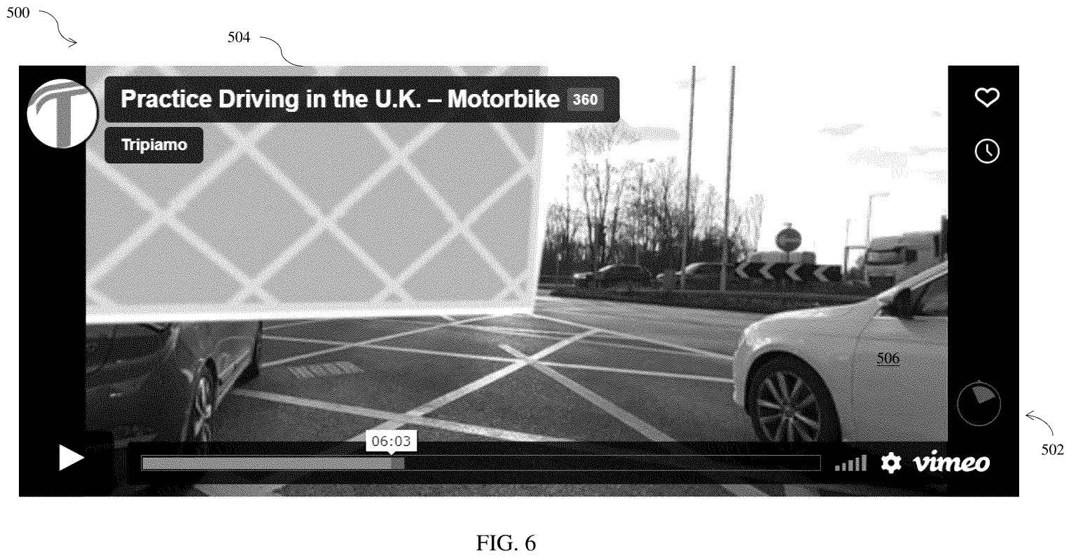

A view icon 502 at the bottom right of a border of the video frame 500 indicates the direction of the video perspective, in this case, straight ahead (0 degrees) with a 60 to 70 degree field of view (FOV) centered at 0 degrees. The graphics module 114 may overlay a graphic of a traffic symbol over the portions of the video that include the actual traffic symbol on the street, as shown in FIGS. 5 and 6. The driving instructor may provide a voice-over audio track to more fully explain how to navigate the particular traffic situation.

FIGS. 5 and 6 show the driver at a “box junction.” A graphic for the box junction 504 is shown in the top center of the video. The driving instructor gives instructions on how to navigate the box junction, including looking to the right to see if there are other vehicles that would prevent the driver from completely crossing the intersection. FIG. 6 shows the user panning to the right, as indicated by the view icon 502. From this perspective, it can be seen that an automobile 506 is to the right of the driver, which must be taken into consideration when deciding to enter the intersection. The graphics module may keep the box junction graphic shown in the video as long as the user's viewing perspective of the actual traffic symbol is shown on the street. Frames may be tagged to indicate to the graphics module when the actual traffic symbol is in the video frame.

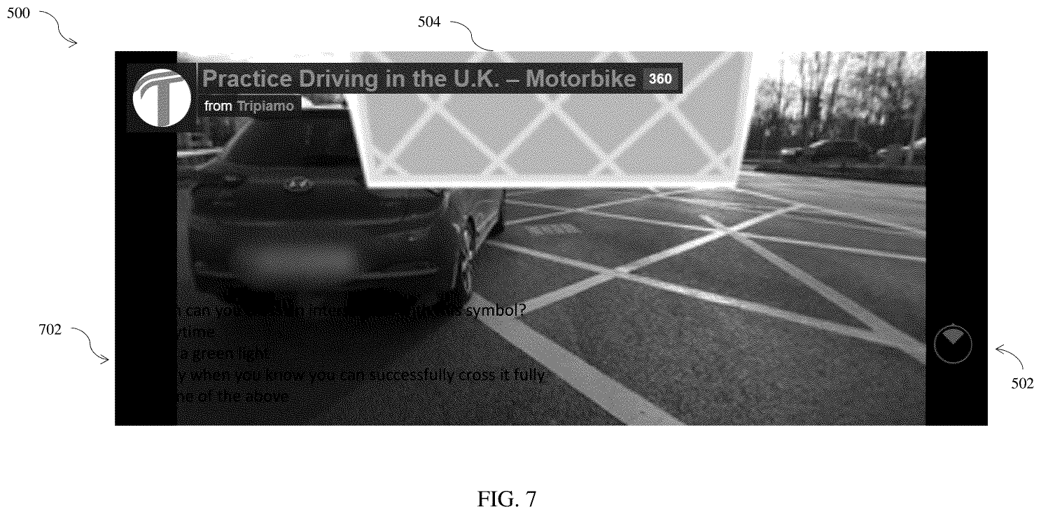

In an embodiment, the graphics module 114 may overlay a quiz onto the video, which the user may answer or skip. FIG. 7 shows text 702 for the quiz, which may be based on information provided by the driving instructor in the audio presentation, or be based on information from other courses in the package. The user may input an answer using a user interface (UI), e.g., a keyboard (physical or virtual), voice entry, pointing device, etc.

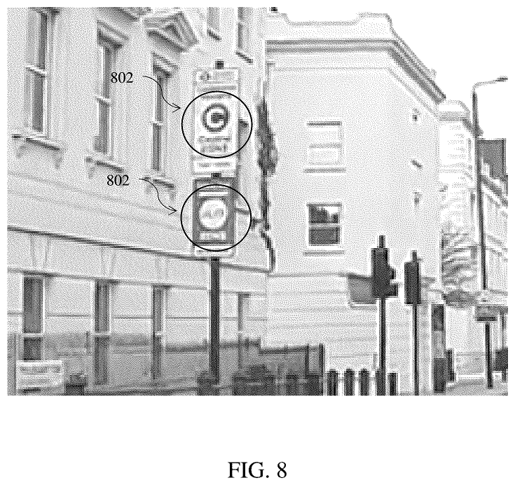

In an embodiment, the graphics module 114 may include “click-on” icons 802 for certain objects in the video frame, for example, traffic signs not described in the instructor's audio commentary, that the user can click on for additional information, as shown in FIG. 8. For example, the click-on icon can be a parking sign in a non-English language, and once clicked on, the information provided may provide an explanation and translation.

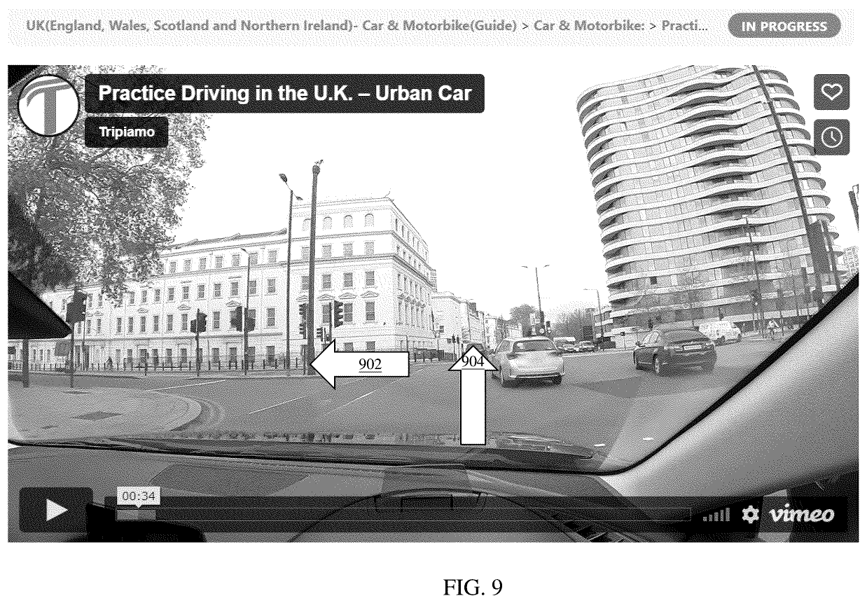

In an embodiment, the system 100 may provide the user with options regarding the route taken when viewing the 360 video. As shown in FIG. 9, at certain intersections, the user may be given the option of going straight, turning left, or turning right. These options may be indicated with arrows, for example, an arrow 902 the user can select to take a left turn and an arrow 904 the user can select to proceed straight through the intersection. In the media database 114, footage for several different routes may be stored. The system may select the video portion corresponding to the user's selection.

The 360 videos may be stored in the media database as static files. However, in some instances, the user may wish to see a specific route to a destination on the user's itinerary for their trip as a “run through”, for example, from the the user's airport to hotel or the user's hotel to a point of interest (POI) such as a restaurant, store, or museum. This may provide the user with an idea of traffic situations the user may encounter on a driving trip to the POI as well as setting familiarity. The system may facilitate this by including a live streaming option in which a local driver 117 (FIG. 1) makes the trip for the user.

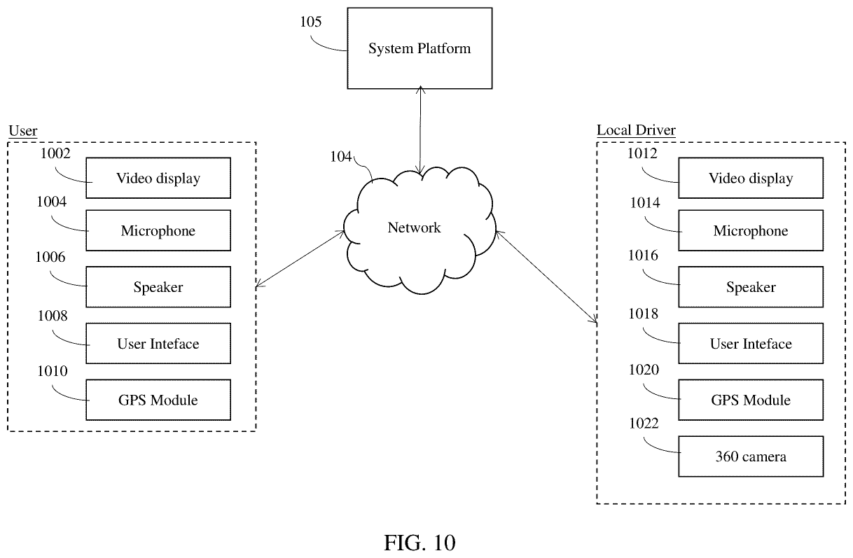

FIG. 10 shows a system for facilitating the live stream experience. The user side may include a video display 1002, a microphone 1004, a speaker 1006, a user interface (UI) 1008, and a global positioning system (GPS) module 1010. In an embodiment, the user may be using a desktop, laptop, or notebook device, or a smartphone or laptop. The video display may be a monitor, the microphone and speaker(s) may be integrated into the device, or be wired or wirelessly connected to the device, and the UI may be a keyboard, mouse, and/or touch screen. In an alternative embodiment, one or more of the video display, microphone, speaker, and UI may be integrated into an augmented reality (AR) or virtual reality (VR) headset connected to the user device. Such devices may include sensors to determine the movement of the user's head, which may be used to change the user's point of view on the 360 video. Other devices may include, for example, Oculus, Google Glass and other AR/VR technologies. Such a headset may also be used with the 360 videos described with reference to FIG. 5.

The GPS module may be integrated into the device modem, or supplied as an application by an outside platform, such as Google Maps, over the network, or handled by a GPS module 118 on the system platform (FIG. 1).

The local driver side may also include a video display 1012, a microphone 1014, a speaker 1016, a UI 1018, a global positioning system (GPS) module 1020, and a 360 camera 1022 mounted on the vehicle. The local driver may use a smartphone and/or integrated audio/video system in an automobile. A motorcycle driver may use a smartphone, wireless speaker/microphone headset and/or a heads-up display integrated into a helmet.

The GPS module 1020 at the local driver's side may be integrated into the device modem, or supplied as an application by an outside platform, such as Google Maps, over the network, or handled by the GPS module 118 on the system platform.

The user may select a destination which may be forwarded to the local driver by the system platform 105. Transmitting the live stream data, communication between user and local driver, and other aspect of the live stream experience may be handled by a live stream module 120 at the system platform.

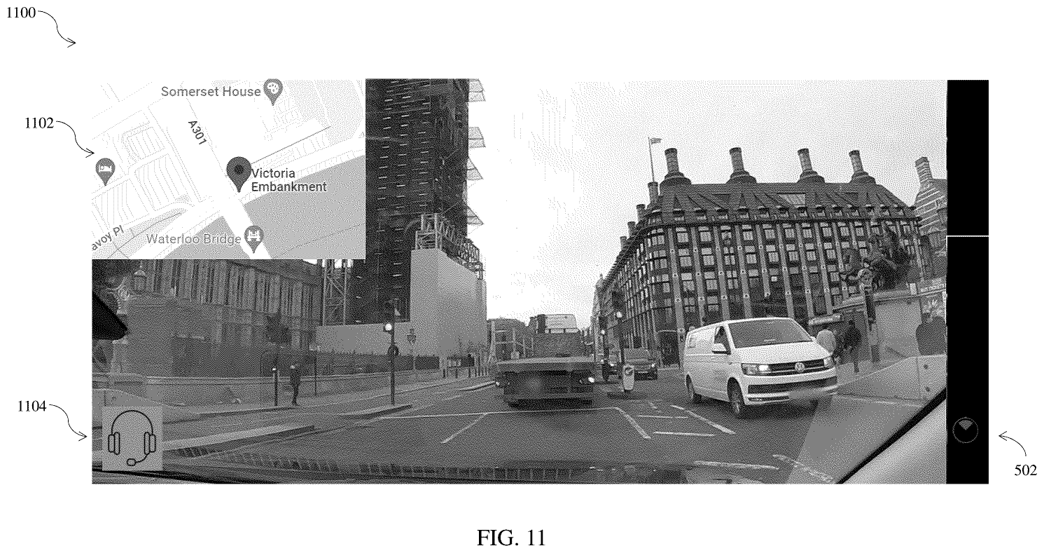

FIG. 11 shows an exemplary display 1100 for a live stream drive with the local driver. The display may include a view selected by the user as indicated by the view icon 502. A map 1102 showing the destination and route progress in a portion of the display. A headset icon 1104 may indicate an audio connection between the user and the local driver.

In an embodiment, the system may provide the user the ability to practice driving in a “metaverse” or “cyberspace” environment. The metaverse may include VR aspects, which may be persistent virtual worlds, as well as AR aspects, which may combine aspects of digital world(s) and the physical world. The system may enable driving instruction and practice in various location around the world, i.e., using real-time footage of a location augmented with graphics and other AR features, a digital representation of a physical location, and/or a digital representation of a simulated virtual world. These features may be facilitated by a VR/AR module 122 at the system platform 105 (FIG. 1).

For example, a user in the United States (US) may practice and learn how to drive in a representation of the UK in the metaverse. They would be able to use the metaverse, which may at some point mimic the entire real-life world and all the existing streets. The user could select a virtual car, a motorbike, bicycle, truck, scooter, etc., and practice driving in an environment that includes digital representations of real-time traffic in specific location as identified by, e.g., government traffic monitoring and CCTV systems, mobile traffic applications used by drivers at the location, satellite imagery, etc. Alternatively, the other vehicles and traffic situations in the metaverse may be generated by the VR/AR module to provide controlled traffic situations for education rather than the random nature of real-life traffic. The other vehicles may also include vehicle avatars for other remote users in a multi-player game-type platform, in which “players” may interact via audio communication, text, etc.

The metaverse feature may also be used for driver education for new drivers in their home country. A driving instructor who may be remote from the user may also be in the metaverse with the user, e.g, as an avatar in the vehicle cockpit, to assist the learning driver.

The various embodiments described above, whether in the metaverse or not, may also be used for driver education purposes for users in their home country. Features available in animated videos and the 360 video embodiments, such as quizzes, instructor commentary, click-on icons, etc., may be tailored to, for example, US driving rules and regulations. The livestream 360 video may be performed with a driving instructor who can provide comments, respond to user questions, and quiz the user in a real-time driving experience. All of these tools may be utilized in different embodiments to provide driver instruction in their home country.

In an embodiment, the system may enable a user to book and reserve a driving instructor in a country of their choice before they arrive. The driving instructor can meet the user at the airport rental car franchise and sit in the car with the user and instruct them on local driving.

The foregoing method descriptions and diagrams/figures are provided merely as illustrative examples and are not intended to require or imply that the operations of various aspects must be performed in the order presented. As will be appreciated by one of skill in the art, the order of operations in the aspects described herein may be performed in any order. Words such as “thereafter,” “then,” “next,” etc. are not intended to limit the order of the operations; such words are used to guide the reader through the description of the methods and systems described herein. Further, any reference to claim elements in the singular, for example, using the articles “a,” “an,” or “the” is not to be construed as limiting the element to the singular.

Various illustrative logical blocks, modules, components, circuits, and algorithm operations described in connection with the aspects described herein may be implemented as electronic hardware, computer software, or combinations of both. To clearly illustrate this interchangeability of hardware and software, various illustrative components, blocks, modules, circuits, operations, etc. have been described herein generally in terms of their functionality. Whether such functionality is implemented as hardware or software depends upon the particular application and design constraints imposed on the overall system. One of skill in the art may implement the described functionality in varying ways for each particular application, but such implementation decisions should not be interpreted as causing a departure from the scope of the claims.

The hardware used to implement various illustrative logics, logical blocks, modules, components, circuits, etc. described in connection with the aspects described herein may be implemented or performed with a general purpose processor, a digital signal processor (“DSP”), an application specific integrated circuit (“ASIC”), a field programmable gate array (“FPGA”) or other programmable logic device, discrete gate logic, transistor logic, discrete hardware components, or any combination thereof designed to perform the functions described herein. A general-purpose processor may be a microprocessor, a controller, a microcontroller, a state machine, etc. A processor may also be implemented as a combination of receiver smart objects, e.g., a combination of a DSP and a microprocessor, a plurality of microprocessors, one or more microprocessors in conjunction with a DSP core, or any other such like configuration. Alternatively, some operations or methods may be performed by circuitry that is specific to a given function.

In one or more aspects, the functions described may be implemented in hardware, software, firmware, or any combination thereof. If implemented in software, the functions may be stored as one or more instructions (or code) on a non-transitory computer-readable storage medium or a non-transitory processor-readable storage medium. The operations of a method or algorithm disclosed herein may be embodied in a processor-executable software module or as processor-executable instructions, both of which may reside on a non-transitory computer-readable or processor-readable storage medium. Non-transitory computer-readable or processor-readable storage media may be any storage media that may be accessed by a computer or a processor (e.g., RAM, flash, etc.). By way of example but not limitation, such non-transitory computer-readable or processor-readable storage media may include RAM, ROM, EEPROM, NAND FLASH, NOR FLASH, M-RAM, P-RAM, R-RAM, CD-ROM, DVD, magnetic disk storage, magnetic storage smart objects, or any other medium that may be used to store program code in the form of instructions or data structures and that may be accessed by a computer. Disk as used herein may refer to magnetic or non-magnetic storage operable to store instructions or code. Disc refers to any optical disc operable to store instructions or code. Combinations of any of the above are also included within the scope of non-transitory computer-readable and processor-readable media. Additionally, the operations of a method or algorithm may reside as one or any combination or set of codes and/or instructions on a non-transitory processor-readable storage medium and/or computer-readable storage medium, which may be incorporated into a computer program product.

The preceding description of the disclosed aspects is provided to enable any person skilled in the art to make, implement, or use the claims. Various modifications to these aspects will be readily apparent to those skilled in the art, and the generic principles defined herein may be applied to other aspects without departing from the scope of the claims. Thus, the present disclosure is not intended to be limited to the aspects illustrated herein but is to be accorded the widest scope consistent with the claims disclosed herein.

1. A system for providing driving instruction, the system comprising:
a system controller;
a media database for storing proprietary media;
a subscriber and information database to store a user's personal and billing information;
a payment processor to process payments from the user using the user's personal and billing information; and
wherein the system controller is operative to provide media from the media database to the user, and
wherein the media database includes a plurality of interactive instructional driving videos, each video including a selectable field of view in a 360 degree range, an instructional audio track, and a plurality of instructional graphics, each graphic overlaid on the driving video at a corresponding point in the video.

2. The system of claim 1, wherein the instructional graphics include graphical representations of traffic signage specific to a user-selected country.

3. The system of claim 1, wherein the instruction graphics include text representing testing material.

4. The system of claim 1, wherein the instructional graphics include a plurality of click-on icons, each click-on icon associated with an object in the video, and
wherein in response to a user selection, the system controller is operative to provide additional information associated with the click-on icon.

5. The system of claim 1, wherein the media database further comprises user-selectable alternative routes for an instructional driving video.

6. A system for providing a live stream driving experience, the system comprising:
a system controller; and
a live stream module operative to receive live stream video from a 360 degree camera mounted on a local driver's vehicle, and
wherein the system controller is operative to transmit the live stream video to a remote user, and
wherein the system controller is operative to facilitate communication between the local driver and the remote user.

7. The system of claim 6, further comprising a global positioning system (GPS) module operative to identify GPS information corresponding to a location of the local driver's vehicle.

8. The system of claim 7, wherein the system controller is operative to generate map data for display on a display device, the map including a representation of the local driver's vehicle location on the map using the GPS information and to transmit the map data to the remote user.

9. The system of claim 7, wherein the system controller is operative to receive GPS data representative of a user-selected destination and transmit the GPS data to the local driver.

10. The system of claim 6, wherein the system controller is operative to manipulate the live stream video to generate a user selected field of view.

11. A system for providing a virtual reality (VR)/augmented reality (AR) driving experience, the system comprising:
a system controller;
a VR/AR module operative to generate a driving environment including digital representations of real world objects,
wherein the system controller is operative to
transmit data representative of the driving environment to a user,
receive data representative of user interactions with the driving environment, and
modify the data representative of the driving environment in response to the user interactions.

12. The system of claim 11, wherein the driving environment comprises a virtual world driving environment including digital representations of vehicles and roads.

13. The system of claim 12, wherein the driving environment is a simulated driving environment.

14. The system of claim 12, wherein the driving environment includes digital representations of traffic in real-time at a user-selected location.

15. The system of claim 11, wherein the driving environment includes real world video overlaid with digital representations.
